(19) United States
(12) Patent Application Publication
(10) Pub. No.: US 2007/0155500 A1
(43) Pub. Date: Jul. 5, 2007

(54) System and Method for Touch Screen Multiplayer Poker Kiosk

(76) Inventor: Edward Scott Honour, Schaumburg, IL (US)

Correspondence Address: Edward Scott Honour, 826 Seers Drive, Schaumburg, IL, 60173, US

(21) Appl. No.: 11/306,231

(22) Filed: Dec. 20, 2005

(51) Int. Cl. A63F 13/00

(52) U.S. Cl. 463/37; 463/13

(57) ABSTRACT

A touch screen computer system and method used to connect to computer based poker games and play poker against other players is provided. The system allows a person to select a poker table from a list of available tables, select a virtual electronic seat at the poker table, and manage all visual elements of game play.

### FIELD OF THE INVENTION

The present invention relates generally to the field of gaming and, more particularly, to a system and a method for allowing people to play multiplayer poker against other people using a touch screen device.

### BACKGROUND OF THE INVENTION

The game of poker has become and extremely popular game that is played in casinos and online. In poker, the player plays against other players and is considered a game of skill. Wagering takes place between players according to the rules of the game, and the operator of the game has no control over the outcome of each game and no reason to care who the winner of each game is. Although wagering takes place in poker, the game is played between players and the player does not play against the casino. Therefore, poker is considered a different type of gaming and legislated by different laws than games such as blackjack or slot machines.

Both online poker and poker played within the casino have drawbacks for the operator of the game. Within a casino a poker game requires a large amount of physical space, the hiring of a dealer, and there must be enough players at the location to operate the game. Because there are many variations on the way the poker game is played, such as betting amounts or betting rules, the casino is faced with the challenge of providing a large number of game variations in a limited space.

Online poker is faced with many jurisdictional issues because the players may not reside in the same legal jurisdiction and the poker game server may be located in a different jurisdiction that may be outside the United States. Therefore, although online poker solves many of the issues faced by casinos, the lack of jurisdictional control makes it difficult for casinos to operate online poker games.

At the same time, the United States government and the individual state government lose out on potential revenue created by online poker games, because there is no ability for the governments to tax the games and no way to ensure that players pay income taxes on their winnings.

Therefore, it would be advantageous to provide an easy to use touch screen system which serves as an “electronic seat” at a poker game, located in a casino or other licensed public venue that are licensed and operated under the laws of a jurisdiction.

### SUMMARY

In view of the deficiencies described above, it is the object of the present invention to provide an improved method for accessing and playing poker games where the game is controlled by a computer system, the players interact with the game by touching regions of a display careen, and the players may be located in a public place.

In accordance with the above objectives, the present invention is the system and method for a touch screen poker device that would be commonly referred to as a poker kiosk. The poker kiosk comprises a display screen where the player communicates with the computer system by touching the screen with their finger or a pointing device, the poker kiosk may or may not include a keyboard or mouse, and a magnetic card reader.

In the preferred embodiment, the system and method allow the player to identify themselves to the poker game by swiping a magnetic card, such as a credit card or stored value card, through a magnetic card reader. In the embodiment, the encoding on the magnetic card would include the player's name, and a unique identification number that is used to identify the player to the poker game and the system of computers that validates whether or not the player is a valid player and manages the player's account.

In the preferred embodiment, the touch screen poker kiosk displays text and graphics that are related to the game. Said text and graphics are provided to the poker kiosk by the computer systems managing the game. Said text and graphics will change based on the game being played and the location of the poker kiosk.

In the preferred embodiment, the system provides instructions to the player related to starting and continuing game play when the player either touches a region of the display screen or swipes their magnetic card through the magnetic card reader.

In the preferred embodiment, an encrypted command language is used to communicate between the poker kiosk and all other computer devices involved with the operation of the game.

In the preferred embodiment, information related to the player is stored in a secure centralized database. Personal information related to the player is not stored on the poker kiosk. Once the player identifies themselves to the poker game, they are provided with options regarding which games they would like to play. In the embodiment, the list of games available to the player is stored and maintained within a central database that may or may not be at the same physical location as the kiosk and may be accessed using the internet or a private network.

In the preferred embodiment the game is controlled by three computer devices. The “validation server” is a computer system containing a database that maintains the account information for each player authorized to play poker. The “lobby server” is a computer system the manages the list of poker games that are available to players, and the “game server” is the computer system that manages the play of each poker game.

In another embodiment, the actions performed by the “validation server”, “lobby server”, and “game server” are consolidated into fewer computers.

In the preferred embodiment, the player chooses the game they wish to join by touching a region of the screen that identifies each game. They may also touch other regions of the screen to display additional games or manage the funds they have on account that is used for play.

Once the player chooses the game they wish to join, the poker kiosk connects to the available poker game using the internet or private network if the computers controlling the game are located in the same physical location as the poker kiosk. In the preferred embodiment, the poker kiosk connects to the game server using a virtual private network that ensures each poker kiosk on the game is properly authorized to participate in the game.

Once the poker kiosk is connected to the game server, the embodiment displays an up to the second graphical representation of the poker game and icons representing each of the other players at the game and any open seats where a new player can join the game.

In the preferred embodiment, the graphics displayed along with all of the touchable regions on the display are managed by the computer controlling the poker game which is referred to as the poker game server. Thus, the same poker kiosk may look completely different when it is connected to different games.

In the preferred embodiment, a player can watch a game from a poker kiosk without participating and can join a game by touching the icon representing an available seat at the poker game. Once the player identifies their intention to join the game, the player makes their choices related to joining the game by touching regions of the screen.

Once the player has joined the game, all elements related to game play using an embodiment of the invention such as betting, folding, calling, or sitting out of a hand are controlled by touching regions of the screen on the poker kiosk.

The present invention is a method for controlling access and managing poker game play on a computer network.

Furthermore, the present invention encompasses a manner of updating and maintaining the gaming software that is located on each poker kiosk which is provided via the present invention. The process includes regularly or periodically updating the poker kiosk with new software and graphics, and deleting unused software and graphics.

### BRIEF DESCRIPTION OF THE DRAWINGS

FIG. 1 is a perspective view of one embodiment of a touch screen poker kiosk.

FIG. 2 is a view of one embodiment of a poker game display in accordance with a preferred embodiment of the present invention.

FIG. 3 is a block diagram illustrating the relationship of components of a online poker game network in accordance with a preferred embodiment of the present invention.

FIG. 4 is a flowchart of a process used for identifying a player to the poker game.

FIG. 5 is a flowchart of a process used for displaying the games available to the player.

FIG. 6 is a flowchart of the process used when a player touches the screen with a finger or pointing device.

FIG. 7 is a diagram illustrating the address of a poker game.

FIG. 8 is a flowchart of a process used for connecting to a poker game.

FIG. 9 is a flowchart of a process used for requesting an action from a poker kiosk.

### DETAILED DESCRIPTION

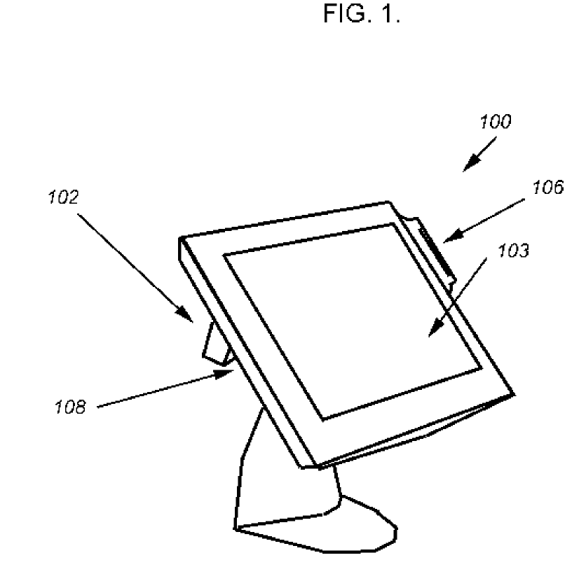

With reference now to the figures and in particular with reference to FIG. 1, a pictorial representation of a touch screen data processing system in which the present invention may be implemented is depicted in accordance with a preferred embodiment of the present invention. A computer 100 is depicted which includes a system unit 102, a video display terminal with touch recognition capabilities 103, storage devices 108, which may include CD-ROM drives and other types of permanent and removable storage media. Additional devices may be included with the computer 100, such as, for example, a magnetic card reader 106 a microphone, sound card, speakers, and the like. Computer 100 may be implemented using any suitable computer with touch screen capabilities. Although the depicted representation shows a computer where all components are located within a single device, other embodiments of the present invention may be implemented on other types of data processing equipment, such as a personal computer containing a separate system unit and a touch screen monitor.

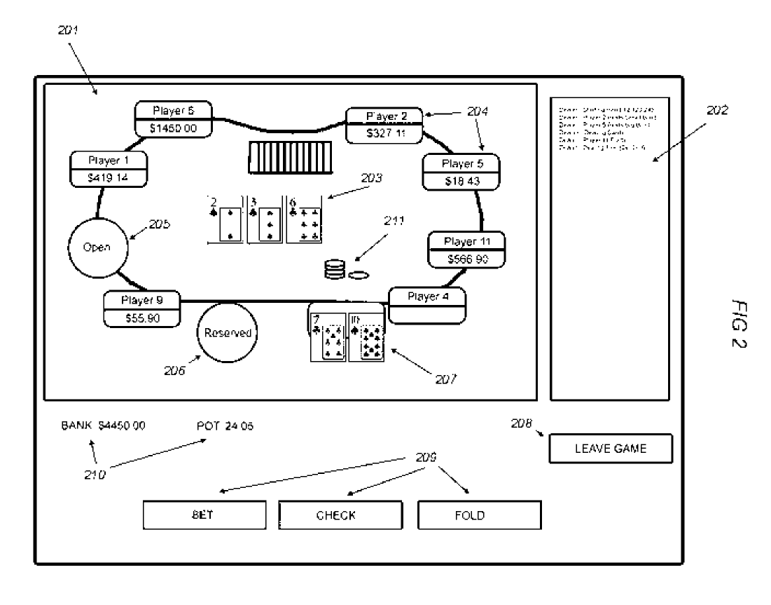

With reference now to FIG. 2, a depiction of a display of a touch screen data poker game is shown in which the present invention may be implemented. Touch screen display 200 contains the graphic image of the poker table 201 which is displayed based on the game being played on the poker kiosk. The display contains a rolling list of game notes 202 telling the player each event that occurs when the game is played. These notes include the beginning of each hand of poker, the betting action of each player, and the cards dealt by the dealer for the flop, turn, and river, among other things. The graphic display of the cards dealt is also displayed 203 on the screen 200. Each occupied seat at the table is represented by an icon 204 that includes a name describing the player and the amount of money the player has at the table. Each available seat at the table is represented by an icon 205 that can be touched by a new player to join the game. Upon touching the icon to join the game at the seat, the player has the option of selecting the amount of money that the player will bring to the table. When a player is in the process of taking a seat all other players see an icon 206 representing a seat that has been reserved. When the player is active in a game the cards dealt to the player is displayed as a representation of the playing cards 207 dealt to the player. A button 208 is presented on the display that allows the player to leave the game at any time. When the player has the option of making an action related to the game, buttons 209 are presented on the display that can be touched by the player to take the action related to the button. Labels 210 are displayed on the screen that show the amount of money the player has on hand and the size of the current pot. A graphical representation of the money contained in the pot is displayed as chips 211.

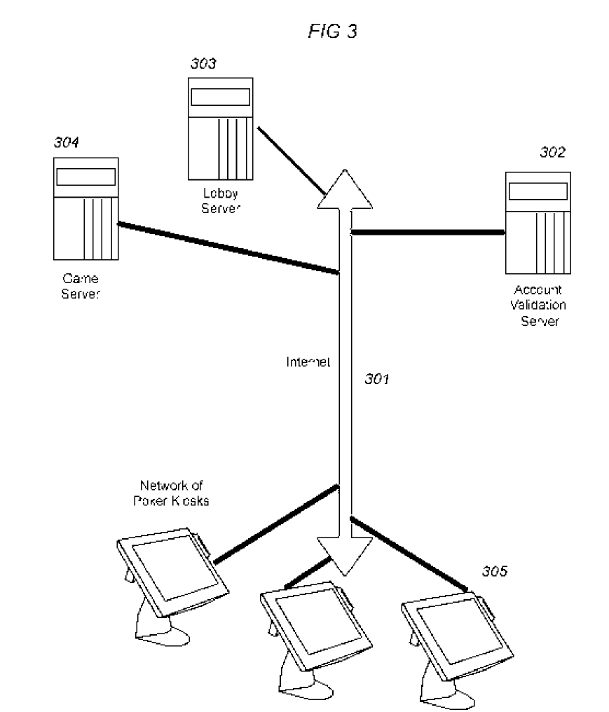

Turning now to FIG. 3, a block diagram illustrating the relationship of components of an online poker game network in accordance with a preferred embodiment of the present invention. The internet 301 is used as the communication network between the kiosks and the servers involved in the system. In the embodiment shown, the account validation server 302, the lobby server 303, and the game server 304 are shown as separate equipment, but they can be consolidated into fewer computers or expanded to use more computers. The poker kiosks 305 communicate with the validation server 302 in order to ensure that the player using the kiosk has an account on the system. The poker kiosks 305 receive the addresses of the poker games available on the games servers 304 along with a description of each game and information related to the players playing each game from the lobby server 303. The poker kiosks 305 communicate with the game server 304 to play the poker game.

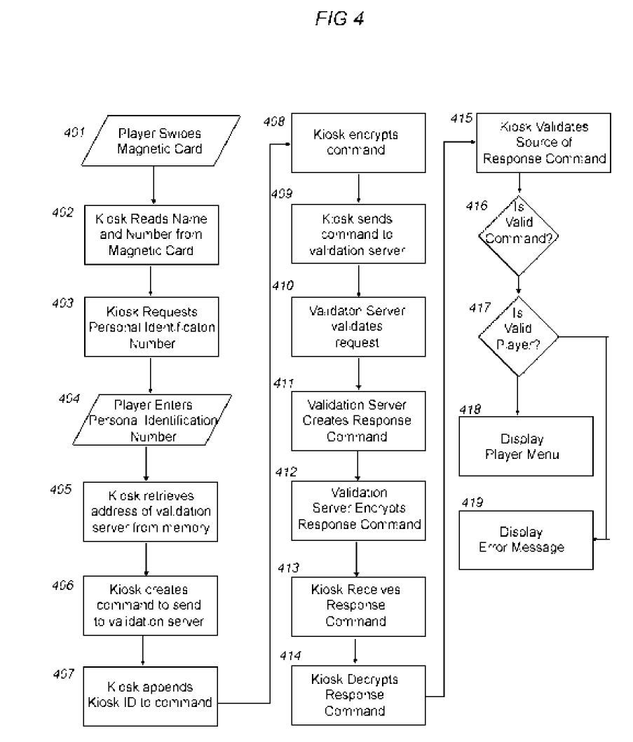

Turning now to FIG. 4 a flowchart of a process used for identifying a player to the poker game. When the player wishes to begin using the poker kiosk they swipe their magnetic card in step 401. In step 402, the kiosk reads the name and identification number from the magnetic card swiped by the player. In the next step 403, the kiosk requests the player's personal identification number from the player and the player enters the number in step 404. During the process, the kiosk maintains the address of the account validation server in memory, and in step 405, the kiosk retrieves the address of the validation server from memory. In step 406, the kiosk creates a command in the format expected by the validation server which includes the name and number from step 402 and the personal identification number entered in step 404. In the next step 407, the kiosk appends the kiosk ID to the command. Once the command is formed in steps 406 and 407 it is encrypted in step 408 prior to being sent to the validation server in step 409. In step 410, the validation server validates the request by verifying the information provided to the validation server in the validation database. The results of the verification are used in step 411 to create a response command that is encrypted by the validation server in step 412 and received by the kiosk in step 413. In step 414 the kiosk decrypts the response command sent by the validation server. Prior to executing the response command, the kiosk executes step 415 to ensure that the response command was sent by the validation server and not sent by an unauthorized source. In step 416, the kiosk determines if the command is a valid command and step 417 processes the result. If the player is not a valid player, an error message is displayed in step 419. If the player is a valid player, step 418 is processes to display the player menu.

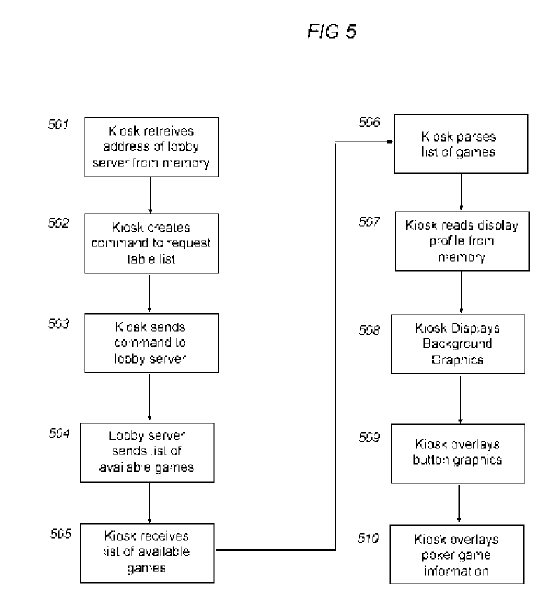

Turning next to FIG. 5 a flowchart of a process used for displaying the games available to the player. In step 501, the kiosk retrieves the address of the lobby server where that names and addresses of all available poker games are stored. In step 502, the kiosk creates a command in memory to request the lists of tables available for the player at the time of the request. The kiosk sends the request to the lobby server in step 503. In step 504, the lobby server sends the list of available games back to the kiosk. In step 505, the kiosk receives the list of available games from the lobby server. In step 506, the kiosk parses the list of games storing the formatted list in memory. In step 507, the kiosk reads the display profile which manages the graphics format from memory. In step 508, the kiosk displays the background graphics that cover the entire display screen. In step 509, the kiosk software overlays the graphic areas that represent the touchable regions of the display representing each game the player can select. The step 510, the textual information related to the game is displayed over the touchable regions representing each game.

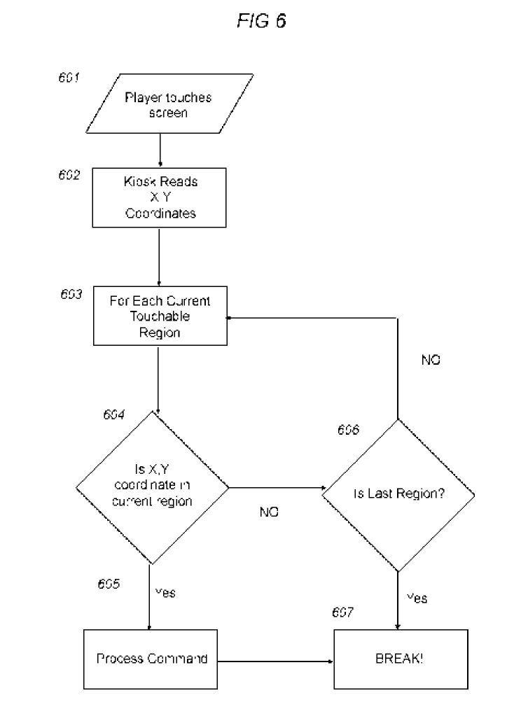

Turning next to FIG. 6 a flowchart of the process used when a player touches the screen with a finger or pointing device. In step 601, the player touches the display screen. In step 602, the kiosk reads the coordinates of the impact. Steps 603, 604, and 606 are processed for each active touchable region on the current display screen. Step 603 represents a processing loop. In step 604, the coordinates of the impact are compared to the coordinates of the current region. If the location of the player's touch is within the touchable region, step 605 executes the command related to the command and the process is terminated. If all of the active regions are checked and the player's touch is not within an active region, step 606 executes step 607 to exit the process without executing a command.

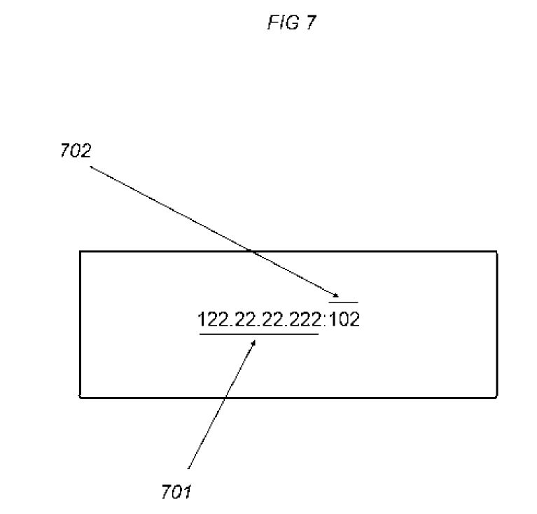

Turning next to FIG. 7 a diagram illustrating the address of a poker game. The address of a poker game connected to by a kiosk is represented. The IP address of the game 701 and the port number 702 where the communication occurs. Any time a communication occurs between the kiosk and the game server, the address is represented in this form.

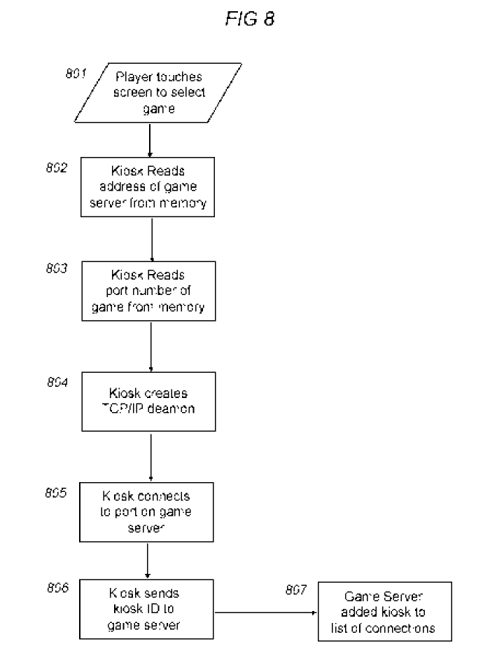

Turning next to FIG. 8 a flowchart of a process used for connecting to a poker game. In step 801 the player touches the screen to select the game they want to play. In step 802 the kiosk reads the address of the game selected by the player. In step 803 the kiosk reads the port number of the port where the communication occurs. In step 804 the kiosk creates a daemon process that is controls communications between the kiosk and the game server. In step 805, the daemon process connects to the port retrieved in step 803 and in step 806 sends the kiosk identification number to the game server. In step 807 the game servers adds the kiosk to the list of connections the game server communicates with.

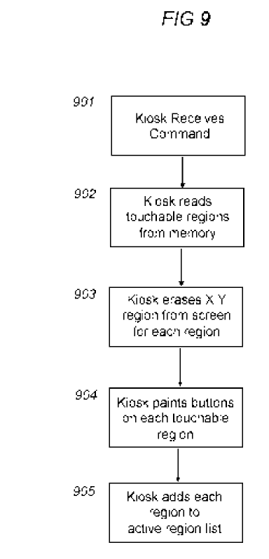

Turing next to FIG. 9 a flowchart of a process used for requesting an action from a poker kiosk. In step 901, the kiosk receives a command from the game server. In step 902, the kiosk reads the active touchable regions from memory and in step 903 the kiosk erases all of the regions from the screen that will be displayed as touchable regions. In step 904 the kiosk paints buttons on each touchable region. In step 905, the kiosk adds each region to the active region list.

What is claimed is:

1. A touch screen computer system and method comprising: at least one display device; a touch screen controller; a network connection; and a magnetic card reader; with the computer configured to connect to a computer system managing a poker game.

2. The method of claim 1, wherein the actions processed by the computer system is based upon the locations on the X and Y axis touched by the player using the end of their finger or a pointing device.

3. The method of claim 2 wherein the computer system determines whether the coordinates on the X and Y axis is a location relating to a command which should be processed by the system.

4. The method of claim 2 wherein the computer system determines whether the screen was touched at a time where the player is allowed to process a command.

5. The method of claim 1, wherein the touch screen computer is configured to connect to a management computer where the list of available poker tables is located.

6. The method of claims 1 and 5 where the touch screen computer system connects to the management computer using TCP/IP.

7. The method of claim 1, wherein the touch screen computer is configured to connect to a computer system that controls the elements of game play for one or more poker tables.

8. The system and method in claims 1 and 7, where the computer controlling the elements of game play is accessible via the internet.

9. The system and method in claims 1 and 7, where the location on the network of the computer controlling the elements of game play is located by IP address.

10. The system and method in claims 1, 7, and 9 where the touch screen computer plays communicates with the computer controlling the elements of game play via a TCP/IP port.

11. The method of claim 1, wherein the player can identify themselves by swiping a magnetic card through a magnetic card reader.

12. The method of claim 11, wherein the magnetic card used to identify the player contains the name of the player.

13. The method of claim 11, where the magnetic card used to identify the player contains a unique number used to identify the player.

14. The method of claim 1, wherein the player is required to enter a personal identification number to validate their identity to the system.

15. The method of claims 1, 12, 13, and 14 where the player's name, identification number, and personal identification number is transmitted to a computer system used for validating player accounts.

16. The method of claim 15 wherein the computer system used for validating player accounts is accessible via the internet.

17. The method of claim 15 and 16 wherein communications with the computer system used for validating player accounts is secured using an encryption algorithm such as Secure Sockets Layer (SSL).

18. The method of claim 5 wherein the list of available poker games is displayed in a graphical representation.

19. The method of claim 18 wherein the player can search for additional poker games by touching a region of the computer screen.

20. The method of claim 18 wherein the player can select a poker game to join by touching a region of the computer screen.

21. The method of claim 5 wherein the list of upcoming tournaments is displayed in a graphical representation.

22. The method of claim 21 wherein the player can register for a poker tournament by touching regions of the computer screen.

23. The method of claim 1 wherein the amount of money the player has on available for play is displayed on the computer screen.

24. The system and method of claim 1 and 23 wherein the player can use the magnetic card and a credit card to add funds to their amount of available money for play.

25. The system and method of claim 1 and 23 wherein the player can add funds to their amount money available for play by purchasing a stored value card.

26. The system and method of claims 1 and 23 wherein the player can add funds to their amount of money available for play by visiting the cashier at a casino or race track.

27. The system and method in claim 1 where the computer is configured to display a graphical representation of the poker game the player is participating in.

28. The system and method of claims 1 and 7, wherein the graphics displayed on the screen is managed and controlled by the computer system in claim 7.

29. The system and method of claims 1 and 7 where communications is performed using a command language.

30. The system and method of claims 1, 7, and 29 where the each command in the command language contains a command and 1 or more optional parameters.

31. The system and method of claims 1, 7, 29, and 30 where each parameter is separated by a delimiter.

32. The system and method of claims 1, 7, 29, and 30 where each command is terminated by a termination character.

33. The system and method of claims 1, 7 and 29 where one or more commands may be sent or received at one time.

34. The system and method in claims 1 and 29 wherein a command may control graphical animation on the computer system.

35. The system and method in claims in and 29 wherein a command may display text on the computer screen.

36. The system and method in claims 1 and 29 wherein a command may prompt a player for a response.

37. The system and method in claim 29 wherein a command may cause the player to leave the game.

38. The system and method of claim 1 where software upgrades of the touch screen poker kiosk are received through the computer network automatically.

39. The system and method in claim 38 wherein the software on the touch screen poker kiosk is referred to by a version number.

40. The system and method in claim 39 wherein the version of the software located on the touch screen poker kiosk is regularly checked against the latest version of the software.

41. The system and method of claim 1 where he computer system identifies itself to the network as a licensed participant in the network.

42. The system and method of claims 1 and 29 where a license code identifying the touch screen computer as a licensed participant in the network is appended to each command sent to the poker game controller.

43. The system and method of claim 1 and where the player selects a seat at a poker game by touching a region of the screen that represents the seat where the player would like to sit.

44. The system and method of claim 1 where the total amount of funds kept on account by the player is available to the player to bring to the table as long as the amount does not exceed the limits for the table.

45. The system and method of claim 1 where the player selects the amount of money they wish to bring to the table by touching a region of the screen.

46. The system and method of claim 1 where a region of the screen is displayed to represent each of the other players who are also playing at the table.

47. The system and method of claim 1 where a region of the screen is displayed to represent each of the seats of the table that are not occupied.

48. The system and method of claims 1 and 2 where a region of the screen is displayed to allow the player to make actions related to game play.

49. The system and method of claim 1 where the computer system controlling the poker table deals two cards to the player that are visible to the player.

50. The system and method of claim 1 where the computer system controlling the poker table deals two cards to each of the other players participating in the game that are not shown to the player and are represented by the back side of the cards.

51. The system and method of claims 1, 2 and 48 where a region of the screen is presented where the player can fold their hand.

52. The system and method of claims 1, 2, and 48 where a region of the screen is presented allowing the player to sit out of a hand.

53. The system and method of claims 1, 2, and 48 where a region of the screen is presented allowing the player to post a bet.

54. The system and method of claim 1 where the first three cards referred to as the flop are displayed on the screen for all players participating in the game to see.

55. The system and method of claims 1, 2 and 48 where the player chooses the amount they would like to bet during each betting round by touching regions of the screen.

56. The system and method of claims 1 and 56 where the computer system decrypts the commands received via the network from the computer managing the poker game.

57. The system and method of claims 1 and 34 where regions of graphics displayed on the screen are controlled and managed based on the physical location of the computer system.

58. The system and method of claim 1 where the computer system encrypts commands and player actions prior to sending them to the computer controlling the poker game.

59. The system and method of claims 1 and 34 where the amount of money bet during the hand by each player is displayed as poker chips at the table.

60. The system and method of claims 1 and 2 where the next action of the player can be set ahead of time by touching a region of the screen.
